(19) United States
(12) Patent Application Publication
(10) Pub. No.: US 2007/0127863 A1
(43) Pub. Date: Jun. 7, 2007

(54) System and method for guiding light from an interrogation zone to a detector system

(75) Inventors: Nathaniel C. Bair, Ann Arbor, MI (US); Richard L. Fisher, Ann Arbor, MI (US); Collin A. Rich, Ypsilanti, MI (US)

Correspondence Address: SCHOX PLC, 209 N. MAIN STREET #200, ANN ARBOR, MI, 48104, US

(73) Assignee: Accuri Instruments Inc.

(21) Appl. No.: 11/297,170

(22) Filed: Dec. 7, 2005

(51) Int. Cl. G02B 6/00

(52) U.S. Cl. 385/12

(57) ABSTRACT

An optical system for guiding light from an interrogation zone to a detector system. The optical system includes an optical device, a first waveguide, and a second waveguide. The optical device is preferably adapted to collect and partition light into a first channel and a second channel of substantially similar light from a substantially singular orientation of the interrogation zone. The first waveguide is preferably adapted to guide the first channel from the optical device to a detector system without substantial interruption. Likewise, the second waveguide is preferably adapted to guide the second channel from the optical device to a detector system without substantial interruption. Preferably, the light of the first channel can be filtered without affecting the light of the second channel, and the light of the second channel can be filtered without affecting the light of the first channel.

### TECHNICAL FIELD

This invention relates generally to the optical field, and more specifically to a new and useful optical system in the flow cytometry field.

### BACKGROUND

As shown in FIG. 4, the conventional optical system for flow cytometers includes a collecting lens to collect light from the interrogation zone, beam splitters to split the light into different channels based on wavelength, and several detector subsystems with filters to pass only particular wavelengths (such as 515-545, 564-606, and 653-669 nm).

To use the conventional optical system, the beam splitters and filters must be arranged in a very particular order (monotonically increasing or decreasing order). For example, the first beam splitter must split between the two lower frequency bands, the first detector subsystem must filter between the lowest frequency band, the second beam splitter must split between the two higher frequency bands, the second detector subsystem must filter between the middle frequency bands, and the third detector subsystem must filter between the highest frequency bands. To change the wavelength detection of the conventional optical system (for example, to replace the frequency band that is originally the highest with a frequency band that is now the lowest), would require the re-arrangement of the entire optical system (including swapping both filters and beam splitters). In other words, with a conventional optical system, the step of filtering the light of the first channel affects the light of the second channel.

Thus, the user must skillfully arrange the filters in a particular order or the detector subsystems will not function correctly. This limitation prevents the easy swapability of the filters and the easy modification of detection parameters. Further, the particular arrangement of the optical table decreases the reliability and the ruggedness of the flow cytometer since the alignment of the beam splitters affects the detection of all three detector subsystems.

Thus, there is a need in the flow cytometer field to create a new and useful optical system. This invention provides such new and useful optical system.

### BRIEF DESCRIPTION OF THE FIGURES

FIG. 1 is a schematic representation of the preferred embodiment of the invention with the first variation of the optical device.

FIG. 2 is a cross-sectional view of the second variation of the optical device (on the left) and a cross-sectional view of the first channel and the second channel (on the right).

FIG. 3 is a schematic representation of the preferred embodiment of the invention with a detector subsystem, a filter, and a collimating lens.

FIG. 4 is a schematic representation of a conventional optical system for flow cytometers.

### DESCRIPTION OF THE PREFERRED EMBODIMENTS

The following description of the preferred embodiment of the invention is not intended to limit the invention to this preferred embodiment, but rather to enable any person skilled in the art to make and use this invention.

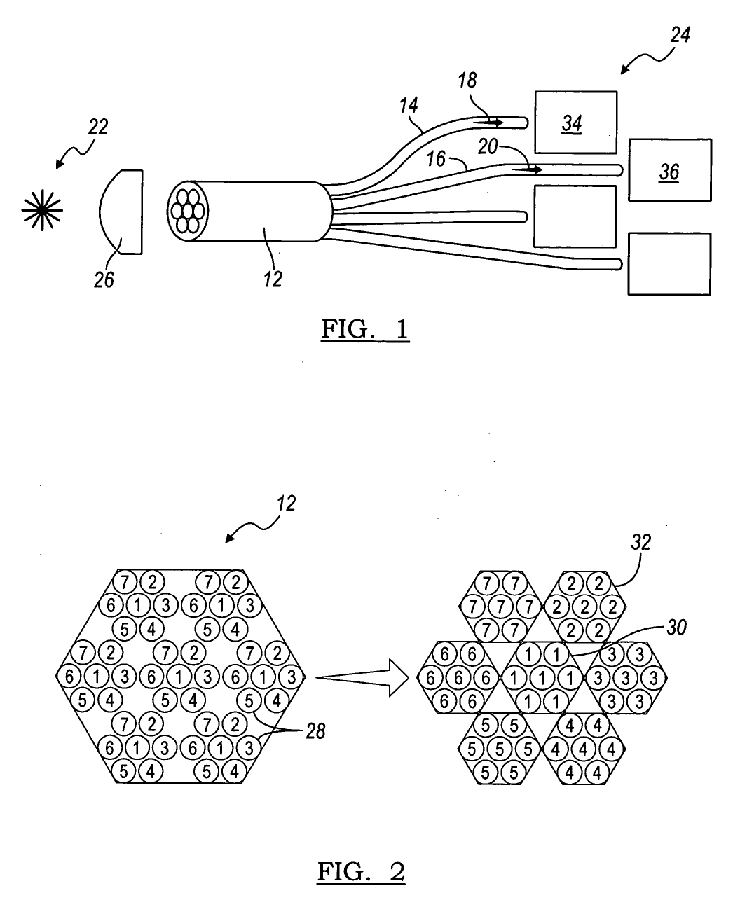

As shown in FIG. 1, the optical system 10 of the preferred embodiment includes an optical device 12, a first waveguide 14, and a second waveguide 16. The optical device 12 is preferably adapted to collect and partition light into a first channel 18 and a second channel 20 of substantially similar light from a substantially singular orientation of the interrogation zone 22. The first waveguide 14 is preferably adapted to guide the first channel 18 from the optical device 12 to a detector system 24 without substantial interruption. Likewise, the second waveguide 16 is preferably adapted to guide the second channel 20 from the optical device 12 to a detector system 24 without substantial interruption. Preferably, the light of the first channel 18 can be filtered without affecting the light of the second channel 20, and the light of the second channel 20 can be filtered without affecting the light of the first channel 18. The optical system 10 has been specifically designed for guiding light from an interrogation zone 22 to a detector system of a flow cytometer. The optical system 10 could, however, guide light to a detector system in a spectrophotometer or any other instrument that observes or measures scattering and/or fluorescence.

The optical device 12 of the preferred embodiment functions to collect and partition light into a first channel 18 and a second channel 20 of substantially similar light from a substantially singular orientation of the interrogation zone 22. In a first variation, the optical device 12 simply includes the collection of the entrance portions of the first waveguide 14 and the second waveguide 16. The first waveguide 14 and the second waveguide 16 of this variation preferably include multiple optical fibers (on the order of 50+ optical fibers), but may alternatively include any suitable number of any suitable waveguides. Thus, by the close proximity of the entrance portions of the first waveguide 14 and the second waveguide 16, the optical device 12 collects light from a substantially singular orientation of the orientation zone.

In a second variation, the optical device 12 further includes a collecting lens 26. The collecting lens 26 of this variation functions to collect light at different angles from the interrogation zone 22 and to substantially collimate this light such that the first waveguide 14 and the second waveguide 16 receive substantially similar light with substantially similar wavelength parameters. Thus, with the use of the collecting lens 26 and the close proximity of the entrance portions of the first waveguide 14 and the second waveguide 16, the optical device 12 of this variation collects substantially similar light from a substantially singular orientation of the orientation zone.

In a third variation, as shown in FIG. 2, the optical device 12 includes distributed sub-channels 28. Although the distribution of the sub-channels 28 is preferably substantially determined and substantially even (as shown), the distribution may be substantially random. A first portion 30 of the sub-channels 28 is preferably combined into the first channel 18, while a second portion 32 of the sub-channels 28 is preferably combined into the second channel 20 (which are exemplified in the drawings as the combination of the sub-channels 28 with the label “1” and the combination of the sub-channels 28 with the label “2”, respectively). The first waveguide 14 and the second waveguide 16 of this variation preferably include multiple sub-channels 28 (on the order of 50+ optical fibers), but may alternatively include any suitable number of sub-channels 28. The distribution of the sub-channels 28 in this variation functions to collect and partition the light from the interrogation zone 22 into substantially similar light with substantial similar wavelength parameters and substantial similar intensity parameters. Thus, with the use of the distributed sub-channels 28, the optical device 12 of this variation collects substantially similar light from a substantially singular orientation of the orientation zone.

In further variations, the optical device 12 may include any suitable device or any suitable method to collect and partition light into a first channel 18 and a second channel 20 of substantially similar light from a substantially singular orientation of the interrogation zone 22.

The first waveguide 14 and the second waveguide 16 function to guide the first channel 18 and the second channel 20, respectively, from the optical device 12 to a detector system 24 without substantial interruption. Preferably, the waveguides are optical fiber. More preferably, the waveguides are polarization-maintaining optical fiber. Alternatively, the waveguides may include any suitable device or method to guide the first channel 18 and the second channel 20 from the optical device 12 to the detector system 24 without substantial interruption. In this document, the phrase “substantial interruption” is meant to include the use of beam-splitters (such as a prism) and any other device used to refract, reflect, or disperse light. The phrase “substantial interruption” is not meant to include the use of a waveguide (such as an optical fiber) to guide or transport light.

In the preferred embodiment, the optical system 10 further includes a third waveguide to guide a third channel, a fourth waveguide to guide a fourth channel, and a fifth waveguide to guide a fifth channel. In alternative embodiments, the optical system 10 may include any suitable number of waveguides to guide any suitable number of channels.

In the preferred embodiment, the optical system 10 further includes a detector system 24. The detector system 24 functions to measure the first channel 18 and the second channel 20. In a first variation, the detector system 24 includes a first detector subsystem 34 that receives the first channel 18, and a second detector subsystem 36 that receives the second channel 20. In a second variation, the detector system 24 includes one detector that receives a multiplexed combination the first channel 18 and the second channel 20 after these channels have been separated and filtered for a particular wavelength band. The multiplexing may be accomplished using time multiplexing (with, for example, a rotating mirror), frequency multiplexing, or any other suitable multiplexing technique, and by using an appropriate synchronization device that synchronizes the channels and the detector. The detector system 24 of the second variation is, most likely, more compact and less expensive, although potentially more complex, than the detector system 24 of the first variation. The detector system 24 may alternatively include any suitable device or method to measure the first channel 18 and the second channel 20.

The detector subsystems 34 and 36 of the preferred embodiment function to detect light of a particular channel. Preferably, the detector subsystem includes a photosensor, such as a photomultiplier tube (“PMT”) or a photodiode. Alternatively, the detector subsystem may include any suitable device, such as a camera, to detect light or other electromagnetic energy.

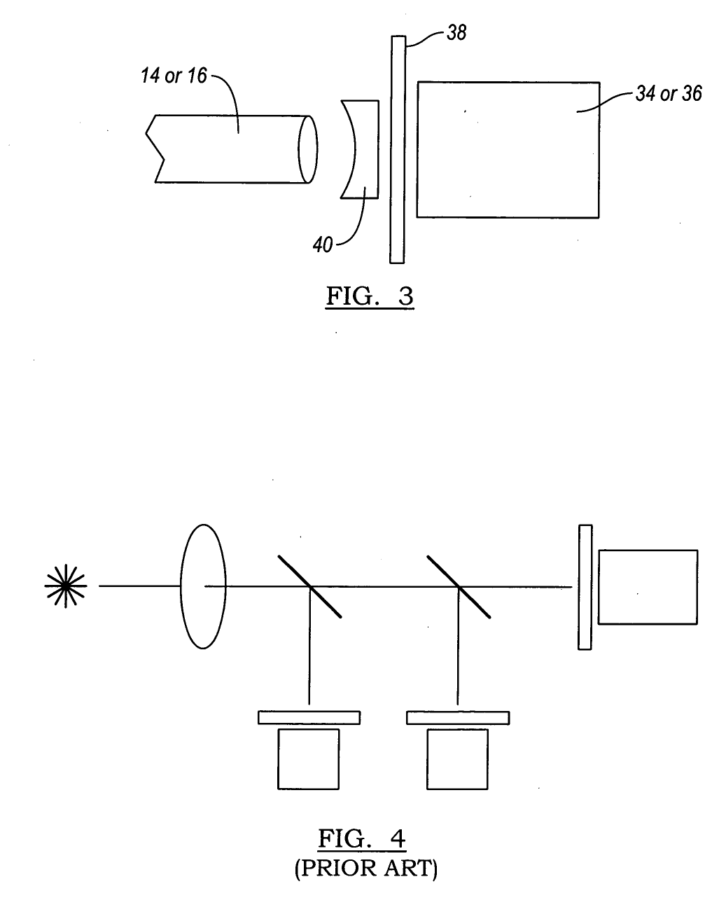

The detector subsystems 34 and 36 of the preferred embodiments further function to detect light of a particular channel within a particular wavelength. To accomplish this function, the detector subsystems 34 and 36 preferably include a wavelength based filter 38, as shown in FIG. 3. In the preferred arrangement, the first detector subsystem 34 and the second detector subsystem 36 filter different wavelengths (such as 488 nm and 530 nm). In an alternative arrangement, the first detector subsystem 34 and the second detector subsystem 36 filter the same wavelengths, which produces a redundant optical system 10 for improved accuracy or for troubleshooting the flow cytometer. The redundancy of the optical system 10 of this variation is made possible by the fact that the light of the first channel 18 and the light of the second channel 20 are substantially similar. One of the advantages of the optical system 10 of the preferred embodiment is that the process of filtering the light of the first channel 18 does not affect the light of the second channel 20, and the process of filtering the light of the second channel 20 does not affect the light of the first channel 18. Furthermore, the process of detecting the light of the first channel 18 does not affect the light of the second channel 20, and the process of detecting the light of the second channel 20 does not affect the light of the first channel 18.

The detector subsystems 34 and 36 of the preferred embodiments further function to focus the light onto the photosensor. To accomplish this function, the detector subsystems 34 and 36 preferably include a collimating lens 40, but may include other arrangements, such as a lens and an aperture. The detector subsystem of alternative embodiments may include other suitable devices, such as a diffraction grating or a prism to sample a specific area of the spectrum.

As a person skilled in the art will recognize from the previous detailed description and from the figures and claims, modifications and changes can be made to the preferred embodiments of the invention without departing from the scope of this invention defined in the following claims.

We claim:

1. An optical system for guiding light from an interrogation zone to a detector system, comprising:
an optical device adapted to collect and partition light into a first channel and a second channel, wherein the first channel and the second channel are substantially similar light from a substantially singular orientation of the interrogation zone;
a first waveguide adapted to guide the first channel from the optical device to a detector system without substantial interruption; and
a second waveguide adapted to guide the second channel from the optical device to a detector system without substantial interruption.

2. The optical system of claim 1 wherein the first channel and the second channel are substantially similar light with substantial similar wavelength parameters.

3. The optical system of claim 1 wherein the first channel and the second channel are substantially similar light with substantial similar intensity parameters.

4. The optical system of claim 1 wherein the optical device includes a lens adapted to collect from a substantially singular orientation of the interrogation zone and to separate the light into the first channel and the second channel of substantially similar light.

5. The optical system of claim 1 wherein the optical device includes distributed sub-channels, wherein a first portion of the sub-channels is combined into the first channel, and wherein a second portion of the sub-channels is combined into the second channel.

6. The optical system of claim 1 wherein the first waveguide and the second waveguide are optical fiber.

7. The optical system of claim 6 wherein the first waveguide and the second waveguide are polarization-maintaining optical fiber.

8. The optical system of claim 1 further comprising a first detector subsystem, wherein the first waveguide is adapted to guide the first channel of light to the first detector system, further comprising a second detector system, wherein the second waveguide is adapted to guide the second channel of light to the second detector subsystem.

9. The optical system of claim 8 wherein the first detector subsystem and the second detector subsystem include a wavelength based filter.

10. The optical system of claim 9 wherein the first detector subsystem and the second detector subsystem include a collimating lens.

11. A method of guiding light from an interrogation zone to a detector system, comprising the following steps:
collecting and partitioning light into a first channel and a second channel of substantially similar light from a substantially singular orientation of the interrogation zone;
guiding the first channel of substantially similar light to a detector system without substantial interruption; and
guiding the second channel of substantially similar light to a detector system without substantial interruption.

12. The method of claim 11 wherein partitioning light into substantially similar light includes partitioning light into substantially similar light with substantial similar wavelength parameters.

13. The method of claim 11 wherein partitioning light into substantially similar light includes partitioning light into substantially similar light with substantial similar intensity parameters.

14. The method of claim 11 wherein the step of collecting and partitioning the light from a singular orientation includes collecting the light with a lens from a substantially singular orientation of the interrogation zone and partitioning the light by separating the light into the first channel and the second channel of substantially similar light.

15. The method of claim 11 wherein the step of collecting and partitioning the light from a singular orientation includes collecting the light with distributed sub-channels and partitioning the light by combining a first portion of the sub-channels into the first channel and by combining a second portion of the sub-channels into the second channel.

16. The method of claim 11 wherein the steps of guiding the first channel and guiding the second channel including guiding with optical fiber.

17. The method of claim 16 wherein the steps of guiding the first channel and guiding the second channel including guiding with polarization-maintaining optical fiber.

18. The method of claim 11 wherein the step of guiding the first channel includes guiding the first channel to a first detector subsystem, and wherein the step of guiding the second channel includes guiding the second channel to a second detector subsystem.

19. The method of claim 18 wherein the first detector subsystem and the second detector subsystem includes a wavelength based filter.

20. The method of claim 19 wherein the first detector subsystem and the second detector subsystem includes a collimating lens.

21. The method of claim 11 further comprising filtering the light of the first channel and filtering the light of the second channel.

22. The method of claim 21 wherein the step of filtering the light of the first channel does not affect the light of the second channel, and wherein the step of filtering the light of the second channel does not affect the light of the first channel.

23. The method of claim 21 further comprising detecting the light of the first channel and detecting the light of the second channel.

24. The method of claim 23 wherein the step of detecting the light of the first channel does not affect the light of the second channel, and wherein the step of detecting the light of the second channel does not affect the light of the first channel.
